(19) United States
(12) Patent Application Publication
(10) Pub. No.: US 2010/0055261 A1
(43) Pub. Date: Mar. 4, 2010

(54) PROCESS FOR THE EXTRACTION OF LYCOPENE

(75) Inventors: Roberto Lavecchia, Rome (IT); Antonio Zuorro, Rome (IT)

Correspondence Address: LUCAS & MERCANTI, LLP, 475 PARK AVENUE SOUTH, 15TH FLOOR, NEW YORK, NY, 10016, US

(73) Assignee: BIOLYCO S.R.L., Lecce (IT)

(21) Appl. No.: 12/513,300

(22) PCT Filed: Nov. 6, 2007
(86) PCT No.: PCT/EP07/61923

§ 371 Date: Jun. 30, 2009

(30) Foreign Application Priority Data
Nov. 7, 2006 (IT) RM2006A000602

(51) Int. Cl. A23L 1/277

(52) U.S. Cl. 426/254

(57) ABSTRACT

The invention discloses a process for the extraction of lycopene from tomato by-products characterised in that said extraction is performed by means of a solvent mixture comprising two or more components, wherein one is apolar or moderately polar and has affinity for lycopene and at least one of the other solvents is polar. As example, a first solvent is an apolar solvent, a second solvent is a protic polar solvent, a third optional solvent is an aprotic polar solvent. In particular, said mixture has the following composition: hexane 10%-80%, ethanol 10%-60% and acetone 10%-60%. The use of multicomponent mixtures characterised by high extractive activity, fast extraction kinetics is one of the advantages of the present invention.

The present invention refers to the field of natural extracts, in particular vegetable extracts. More in particular, the present invention provides a process for the extraction of lycopene from by-products from the tomato processing industry.

### BACKGROUND OF THE INVENTION

Lycopene is an open-chain unsaturated carotenoid which gives the typical red colour to tomatoes and other vegetables.

Said compound has interesting anti-oxidant properties that make it able to contrast the harmful effects of free radicals on the human body, since it accumulates in liver, lung, prostate, colon and skin and its concentration in said tissues is higher than other carotenoids.

Its antioxidant activity is exploited in several therapeutic applications, as for example, cardiovascular diseases, some types of tumor, as prostate cancer (Giovannucci et al., J. Nat. Cancer Inst., 87: 1767-1776 (1995); Clinton et al., Nutr. Rev., 56:35-51 (1998)). Furthermore, lycopene is generally used in the nutritional field and in the cosmetic industry.

Therefore, the industry of natural extracts strongly needs this product and requires a convenient and effective extraction process to obtain a product having suitable characteristics.

Tomato by-products are an important source of lycopene. The attention is particularly drawn to peels that constitute the main fraction of the whole by-product.

Depending on the working process (peeled tomatoes, concentrates, pulps, etc.) the peels content of the humid by-product can be from 45 to 65%. Through, lycopene concentration is higher in peels, nearly 5 times than the in the fruit, peels are a perfect starting material for the production of lycopene.

In reviewing the technical-scientific literature and the patent documentation, only few documents relating to lycopene extraction from tomato peels were found.

Suitable processes are those that extract lycopene from the whole fruit or its derivatives.

Said processes can be classified as supercritical fluid extraction and organic solvent extraction.

In the last few years, supercritical fluid extraction (usually supercritical CO₂ in all applications) has become very important in the alimentary and pharmaceutical industry. Said technology can be suitably applied to lycopene extraction from vegetable matrix, including tomato peels, since carbon dioxide is completely inert and the final product is without contamination from the solvent.

The available data, from laboratory tests or pilot plant, do not lead to definitive results on the real effectiveness of CO₂ supercritical fluid extraction.

The costs of the industrial process are quite high, because of the severe operation conditions (temperature and pressure) and the compulsory use of a cosolvent.

Co-solvents that can remarkably enhance the extraction yield are acetone, methanol, ethanol, vegetable oils (soybean oil, sunflower oil, hazelnut oil).

An other limitation of the supercritical extraction processes is the probable isomerisation of lycopene (from the trans to the cis form).

Finally, the use of raw material with high humidity levels, i.e. tomato by-products, could require additional steps to reduce the water content.

In the alimentary industry, the extraction with organic solvents is a well-known method.

Said technology allows the treatment of by-products as such, by conveniently combining well-established separation or purification processes (evaporation under vacuum, crystallisation, chromatographic or membrane separation) in order to obtain lycopene with the desired purity.

A critical aspect of the extraction with a solvent is the selection of the solvent, that must belong to the classes of compounds that are allowed in the alimentary field and give high enough extraction yield, in order to reduce their concentration and make them easily removable form the final product.

For example, the solvents that are admitted by European Community (Community Directive 95/45/CE), that can be used for the extraction of natural dyes for the alimentary use, are:
ethyl acetate (C₄H₈O₂)
acetone (C₃H₆O)
dichloromethane (CH2Cl2)
hexane (C₆H₁₄)
ethanol denaturated (C₂H₆O)
methanol (CH₄O)
2-propanol (C₃H₈O).

The results of the experiments conducted on tomatoes as such, tomato juice and concentrate, underline that the structure and the features of the vegetable matrix, containing lycopene, strongly influence the extraction yields.

When peels are used, the yields are quite low, even if solvents with high affinity for lycopene are used. Probably, this is caused by the low exposition to the solvent of the lycopene which is localised within the vegetable matrix.

For example, International Application n. WO 2006/036125 discloses a process for the extraction of lycopene from tomato concentrate, by using the whole fruit.

International Application n. WO 2006/032712 discloses a process for the extraction of lycopene from tomato peels, wherein, after the removal of seeds, a first dehydration step is followed by the palletizing of the material and the extraction with hexane, and at the end, by distillation and crystallization. The purity of the final product is between 65% and 85%.

The International Application n. WO 97/48287 provides a process for the extraction of lycopene from tomato pulp using a solvent or a mixture thereof with δ_{H} and δ_{P} between 0.0 and 5.0.

Chinese Patent Application n. 1358801 uses tomato peels as raw material for the extraction of lycopene with ethyl acetate or solvent oil No. 6.

We refer to the previously summarised patent applications as the prior art and to the related technical problems.

Other processes for the extraction of lycopene from tomatoes are known in the art, they use as the raw material the fruit as such or its serum.

Nowadays, the most promising processes for the extraction of lycopene form tomato peels seems to be those using organic solvents.

However, pure solvents give low extraction rates. International Application n. WO 03/79816 discloses a process for the extraction from tomatoes as such by means of a solution of ethyl acetate saturated with water. Lycopene content is between 5% and 20%.

Thus, still exists the technical problem of providing a process for the extraction of lycopene from by-product material deriving from tomato processing, which is difficult to treat even if it contains high percentage of valuable product, and uses easy and cheap industrial technologies.

### SUMMARY OF THE INVENTION

It has now been found that it is possible to extract lycopene from by-product material, coming from tomato processing, by using particular mixtures of solvents.

The use of multicomponent mixtures characterised by high extractive activity, fast extraction kinetics is one of the advantages of the present invention.

It is an object of the present invention a process for the extraction of lycopene from tomato by-product characterised in that said extraction is conducted by means of a solvent mixture comprising two or more components, wherein one is apolar or moderately polar and has affinity for lycopene and at least one of the other solvents is polar.

Said process, generally comprises:
a. Contacting said by-product with a solvent mixture comprising two or more components, wherein one is apolar or moderately polar and has affinity for lycopene and at least one of the other solvents is polar, as herein disclosed in details,
b. Extracting said lycopene from said by-product to obtain an extraction mixture;
c. Isolating said lycopene from said extraction mixture.

This and other objects of the present invention will be described in details in the following section also by means of examples.

### DETAILED DESCRIPTION OF THE INVENTION

“Tomato by-product” means by-product or residues from the industrial processing of tomato. Depending on the working process (peeled tomatoes, concentrates, pulps, etc.) said by-products have a different composition and different physico-chemical properties (humidity, protein content, pectin content, etc.), but in any case, the components that are present in the higher concentration are peels, seeds and pulp fragments.

In a preferred embodiment of the present invention, the by-products comprise mostly tomato peels.

In the meaning of the present invention, “organic solvent” means any organic compound (i.e. a compound containing carbon atoms) in the liquid state under standard conditions, being capable to extract, alone or in admixture with other solvents, the lycopene or other similar compounds (β-carotene, phytoene, phytofluene, etc.).

Depending on their chemical structure, the solvents can be polar or non-polar. Polarity can be evaluated by the dielectric constant or by the dipole moment of the desired compound. Polar solvents can be divided in aprotic polar solvents and protic polar solvents. The former do not contain acid hydrogen atoms.

Typical aprotic solvents are acetone, methylethylketone; while ethanol and acetic acid belong to the protic family.

In the context of the present invention, apolar or moderately polar solvents are intended those solvents having dielectric constant lower than 10, whereas polar solvents are intended those solvents having dielectric constant equal or higher than 10. According to this definition, and to the values of the dielectric constant available in the commonly used laboratory and technical handbooks (Handbook of Solvents, Wypych G., ed., Chem-Tec Publishing: Toronto, 2001; CRC Handbook of Chemistry and Physics, 87^{th} edn, Lide D. R., ed., CRC Press: Boca Raton, Fla., 2006), hexane, ethyl acetate and methyl acetate are intended to be polar solvents or moderately polar solvents. Acetone, ethanol, methanol and water are intended to be polar solvents.

According to the present invention, “aliphatic alcohol” means an organic compound with the general formula R—OH, wherein ‘R’ is a linear or branched alkyl radical with 1 to 4 carbon atoms and ‘OH’ is a hydroxyl group.

The alcohols herein considered are monovalent alcohols, characterised by the presence of only one hydroxide in their molecule.

For example, methanol, ethanol and propanol belong to said group of compounds.

In a first embodiment of the present invention, the extracting mixture is a solvent mixture comprising two or more components, wherein one is apolar or moderately polar and has affinity for lycopene and at least one of the other solvents is polar.

Preferably, extraction mixture essentially consists of hexane or ethyl acetate, ethanol or water and acetone.

More preferably, the extracting mixture has the following composition: hexane 10%-80%, ethanol 10%-60% and acetone 10%-60%, and more preferably: hexane 45%, ethanol 35% and acetone 200%. All the concentrations are indicated as volume/volume (v/v).

In an other preferred aspect, the liquid-solid rate is between 3 and 300 ml/g, more preferably 20 ml/g.

The extraction temperature is not a critical parameter and the person skilled in the art can easily choose the operational temperature range using his general knowledge and considering various factors such as, the material compatibility, the possible degradation of the active ingredient (lycopene) and the mixture composition, or the extraction rate and boiling points. For example, the extraction can be conducted at a temperature between room temperature and 60° C., preferably 40° C. The limits of the range can be approximated in the sense that a downward variation of the lower limit and an upward variation of the upper limit are not excluded from the breadth of the invention, if they do not compromise the result.

Likewise, the extraction time can be evaluated by the skilled in the field by reasonable experimentation. For example, a preferred time range is between 10 and 120 minutes, for example 30.

Conveniently, the extraction is carried out in reduced light or in the dark, in order to avoid photodegradation.

In the case of a first preferred embodiment of the invention, the by-products contain mainly tomato peels, for example in an amount between 40 and 90% (humid by-product).

It can be convenient and desirable to separate peels from by-product.

Better results can be achieved if separated peels undergo to homogenization.

A set of preferred conditions provide hexane concentration (v/v) from 10 to 80%, ethanol and acetone from 10 to 60%; extraction temperature between room temperature and 60° C., extraction time from 10 to 120 minutes and a liquid/solid rate from 10 to 300 ml/g.

Lycopene isolation from the extraction mixture is carried out by means of conventional techniques, belonging to general knowledge in the field and can be found in the relevant literature.

The following example further illustrates the invention.

### Raw Material Preparation

Residues coming from tomato processing can be obtained from processing industry, for example in the production of peeled tomatoes.

By-products can be preserved in hermetic plastic bags on in an other suitable container and freezed at −20° C.

Before proceeding with the extraction process the material is defrosted at 4° C., in an environment far from light and air.

The solvents were used as such.

In the defrosted by-products, peels were separated from seeds and from pulp residues.

Peels were roughly homogenized and, in each sample, undergoing to the extraction tests, humidity was measured.

Humidity of tomato peels was measured by drying in a ventilated stove (NSE, ISCO) until constant weight was reached. Drying was carried out in air at 105° C., using an amount of peels between 0.5 and 1 g.

Several isothermic tests with different times, showed that after around 6 h lost weight reached a constant value.

Lycopene concentration in the samples was measured by a spectrophotometer at a wavelength range of 350-600 nm, after phase separation, by means of a suitable amount of water, for example an amount of 20% of the total extracting volume.

The comparison with pure lycopene in hexane spectra clearly shows that the pigment extracted from the tomato peels mainly contains said carotenoid.

The quantitative determination of lycopene was referred to the peak having the maximum around 503 nm, by using the following value of the molar absorption coefficient: ε=158500 M-1cm-1

### Example 1

The extraction of lycopene from tomato peels is carried our discontinuously in 50 ml glass flasks with screw cap. The flasks were put on a 15-position-multiple-magnetic stirrer (TeleModul, STEUEREINHEIT) in a thermostatic bath with a recirculating criothermostat (RTE 101, NESLAB).

At the beginning of each test 100 g of peels, gravimetrically measured by means of an analytic balance, were transferred in the flask. Then the extraction mixture was added according the present invention (or the single components as comparative tests) in an amount of 3000 ml and maintained under stirring for 30 min.

All the tests were carried out in duplicate, and to minimise lycopene degradation caused by exposure to the light, they were conducted under reduced light conditions. For the same reason, all the sides exposed to light of the container used as the thermostatic bath were covered with opaque material.

The temperature was set at 45° C. and the extraction time was 30 min.

The extraction activity of the single components (hexane, ethanol and acetone) was compared with the yield that could be obtained, under the same conditions, with a mixture having the composition 50:25:25.

The results are shown in the following Table 1, wherein the amount of lycopene (q) is expressed in mg. The following parameter was calculated from this quantitative value (m_{B}) and the humidity (U) of the peels:

$${q}^{′} = \frac{q}{{m}_{B} ( 1 - U )}$$

which represents the amount of extracted lycopene per dry weight unit of the material and gives a quantitative indication of the extraction efficiency.

TABLE 1
Summary of the results.

| | Hexane | Ethanol | Acetone | q′ | σ_{q′} |
|---|---|---|---|---|---|
| Test | [v/v %] | [v/v %] | [v/v %] | [mg/gₛ] | [mg/gₛ] |
| A | 100 | 0 | 0 | 0.320 | 0.109 |
| B | 0 | 100 | 0 | 0.000 | 0.000 |
| C | 0 | 0 | 100 | 0.230 | 0.000 |
| D | 50 | 25 | 25 | 3.309 | 0.288 |

σ_{q′} represents standard deviation of repeated tests.

The most important data that can be underlined is the yield improvement obtained by mixing the three components (in this specific case, in a rate of 50:25:25). The value of q′ of said mixture is one time higher than the value of pure hexane, the extracted lycopene is more than 3 mg for each g of dry material.

### Example 2

Several mixtures were tested under the same conditions of example 1, and gave the following results.

TABLE 2
Summary of the results.

| | Hexane | Ethanol | Acetone | q′ | σ_{q′} |
|---|---|---|---|---|---|
| Test | [v/v %] | [v/v %] | [v/v %] | [mg/gₛ] | [mg/gₛ] |
| E | 80 | 10 | 10 | 2.298 | 0.210 |
| F | 30 | 60 | 10 | 2.673 | 0.050 |
| G | 30 | 10 | 60 | 3.027 | 0.060 |
| H | 55 | 35 | 10 | 3.561 | 0.012 |
| I | 55 | 10 | 35 | 2.993 | 0.021 |
| J | 30 | 35 | 35 | 3.571 | 0.308 |
| K | 46.67 | 26.67 | 26.67 | 3.209 | 0.217 |
| L | 63.33 | 18.33 | 18.33 | 2.716 | 0.013 |
| M | 38.33 | 43.33 | 18.33 | 3.130 | 0.101 |
| N | 38.33 | 18.33 | 43.33 | 3.455 | 0.223 |

σ_{q′} is the standard deviation of the repeated tests.

The results clearly show that:
For all the mixtures of the present example, extraction yields are higher than those of the single components (see example 1);
Extraction yields decrease if the hexane concentration in the mixture raises;
The maximum values of the yields (around 3.6 mg/gₛ) are at points H e J, having an effective ethanol volumetric fraction of 0.35.

### Example 3

Under the same conditions of example 1, but with a liquid/solid rate of 20 ml/g, the results shown in table 3 were obtained.

TABLE 3
Summary of the results.

| | Hexane | Ethanol | Acetone | q′ | σ_{q′} |
|---|---|---|---|---|---|
| Test | [v/v %] | [v/v %] | [v/v %] | [mg/gₛ] | [mg/gₛ] |
| O | 10 | 35 | 55 | 4.120 | 0.249 |
| P | 20 | 35 | 45 | 4.400 | 0.255 |
| Q | 20 | 40 | 40 | 4.539 | 0.015 |
| R | 42.5 | 35 | 22.5 | 4.154 | 0.217 |

σ_{q′} is the standard deviation of the repeated tests.

In practice, the preferred mixture has the following composition:

| | |
|---|---|
| hexane: | 45% |
| ethanol: | 35% |
| acetone: | 20% |

and it can be used under the following operational conditions:

| | |
|---|---|
| Liquid/solid rate: | 30 ml/g |
| Temperature: | 45° C. |
| Extraction time: | 30 min |

And by said mixture it is possible to obtain a concentration of lycopene around 4 mg for each g of dry material.

### Example 4

Under the same conditions of Example 1, but at an extraction temperature of 30, 40 and 60° respectively, the results shown in table 4 were obtained.

TABLE 4
Results summary.

| | Hexane | Ethanol | Acetone | Temperature | q′ | σ_{q′} |
|---|---|---|---|---|---|---|
| Test | [v/v %] | [v/v %] | [v/v %] | ° C. | [mg/gₛ] | [mg/gₛ] |
| S | 45 | 35 | 20 | 30 | 5.819 | 0.25 |
| T | 45 | 35 | 20 | 40 | 6.169 | 0.31 |
| U | 45 | 35 | 20 | 60 | 5.52 | 0.06 |

σ_{q′} is the standard deviation of the repeated tests.

1. Process for the extraction of lycopene from tomato by-products characterised in that said extraction is performed by means of a solvent mixture comprising two or more components, wherein one is apolar or moderately polar and has affinity for lycopene and at least one of the other solvents is polar.

2. Process according to claim 1, wherein said solvent mixture includes a first solvent which is an apolar solvent, a second solvent which is a protic polar solvent, and a third optional solvent which is an aprotic polar solvent.

3. Process according to claim 2, wherein said solvent mixture includes hexane or ethyl acetate, ethanol or water and acetone.

4. Process according to claim 3, wherein said solvent mixture has the following composition: hexane 10%-80%, ethanol 10%-60% and acetone 10%-60%.

5. Process according to claim 4, wherein said solvent mixture has the following composition: hexane 45%, ethanol 35% and acetone 20%.

6. Process according to claim 1, wherein the liquid-solid rate is between 3 and 300 ml/g.

7. Process according to claim 6, wherein the liquid-solid rate is 20 ml/g.

8. Process according to claim 1, wherein the extraction temperature is between 20 and 60° C.

9. Process according to claim 8, wherein the extraction temperature is around 40° C.

10. Process according to claim 1, wherein the extraction time is between 10 and 120 minutes.

11. Process according to claim 10, wherein the extraction time is around 30 minutes.

12. Process according to claim 1, wherein said by-products are mainly formed by tomato peels.

13. Process according to claim 12, wherein the peels are from 40 to 90% of the humid by-product.

14. Process according to claim 12, wherein the peels are separated from the by-product.

15. Process according to claim 15, wherein the separated peels undergo to homogenization.

16. Process for the extraction of lycopene from tomato by-products comprising:
a. Contacting said by-product with a solvent mixture comprising two or more components, wherein one is apolar or moderately polar and has affinity for lycopene and at least one of the other solvents is polar;
b. Extracting said lycopene from said by-product to obtain an extraction mixture;
c. Isolating said lycopene from said extraction mixture.
